(19) United States
(12) Patent Application Publication
(10) Pub. No.: US 2025/0289454 A1
(43) Pub. Date: Sep. 18, 2025

(54) RAPID VEHICLE OPERATION FEEDBACKAND CONTROL FRAMEWORK

(71) Applicant: State Farm Mutual Automobile Insurance Company, Bloomington, IL (US)

(72) Inventor: Christopher Ray, Bloomington, IL (US)

(21) Appl. No.: 18/604,221

(22) Filed: Mar. 13, 2024

(51) Int. Cl. B60W 50/14; B60W 10/04; B60W 10/10; B60W 10/18; B60W 10/22; B60W 40/09; G06Q 40/08

(52) U.S. Cl. CPC B60W 50/14; B60W 10/04; B60W 10/10; B60W 10/18; B60W 10/22; B60W 40/09; G06Q 40/08; B60W 2050/146; B60W 2556/55

(57) ABSTRACT

Described herein are systems and techniques to facilitate rapid (e.g., real-time or near real-time) determination of driving performance and vehicle movements to generate a driving quality score that can then be used to determine rates and discounts for a driver. This information can be provided to the driver along with suggestions for improving driving performance so that the driver can be aware of the financial impact of current driving performance. This information can also, or instead, be used to generate vehicle controls that may improve the driving quality score, thereby increasing safe and efficient operation of the vehicle.

### BACKGROUND

Modern vehicles may be equipped with a variety of sensors and vehicle data systems. For example, modern vehicles may be equipped with cameras, radar, lidar, sonar, inertial sensors, location sensors (e.g., global positioning system (GPS) systems or devices), etc. Modern vehicles may also be equipped with systems to detect and generate data associated with vehicle performance, actions and/or states, such as speed, acceleration, braking (e.g., as deceleration), heading, etc. Modern vehicles are also typically equipped with computer-based vehicle control systems that are configured to control many of the vehicle's drive components. For example, in modern vehicles, the engine, transmission, suspension, and braking systems may be computer-controlled. Such components and/or their associated computer-based controller may also generate data indicating vehicle operating conditions and/or states that may be stored and/or processed for various operations.

Currently, many vehicle insurers offer improved rates and/or discounts based on driver behaviors while operating an insured vehicle (“driving behaviors”) and/or other vehicle operation data that may, for example, be collected by vehicle sensors, vehicle components, and/or computer-based vehicle component controllers. This driving behavior and vehicle operation data may be collected over a period of time (e.g., one month, six months, etc.) and periodically evaluated to determine if a vehicle user qualifies for particular rates and/or discounts. However, the user is not able to determine if the user's current driving behavior and/or vehicle operating condition contribute to or detract from the user's eligibility for particular rates and/or discounts. Therefore, the user may not realize the impact of current driving behaviors and vehicle operation until many weeks or months after the vehicle operation. The examples of the present disclosure are directed to overcoming these deficiencies and providing a framework for determining and providing rapid vehicle operation feedback and control.

### SUMMARY

Techniques described herein implement a rapid vehicle operation feedback and control framework that facilities the rapid (e.g., real-time or near-real-time) determination of the effects of driving behavior and vehicle operation on rates and discounts of various types (e.g., insurance premium, insurance premium discounts, vehicle usage rates, voice usage discounts, etc.). The determined effects may be used to provide suggestions to a driver to improve rates and/or discounts and/or to control a vehicle to improve rates and/or discounts.

For example, the techniques described herein may relate to a method comprising receiving, at a computing system from a mobile computing system, while the mobile computing system is nonstationary, sensor data representing one or more movements of the mobile computing system; determining, at the computing system, while the mobile computing system is nonstationary, a quality value based at least in part on the one or more movements of the mobile computing system; determining, at the computing system, while the mobile computing system is nonstationary, a pricing element based at least in part on the quality value; determining, at the computing system, while the mobile computing system is nonstationary, an alternative quality value based at least in part on one or more alternative movements of the mobile computing system; generating, at the computing system, while the mobile computing system is nonstationary, instructions to present a data element on a display, the data element comprising an indication of at least one of the one or more alternative movements of the mobile computing system; and transmitting the instructions from the computing system to the mobile computing system while the mobile computing system is nonstationary.

The techniques described herein may also relate to determining the one or more movements of the mobile computing system based at least in part on the sensor data. The techniques described herein may further relate to transmitting, from the computing system to the mobile computing system while the mobile computing system is nonstationary, second instructions to control one or more vehicle components at a vehicle at which the mobile computing system is configured. The one or more vehicle components comprise one or more of an engine control system, a braking control system, a transmission control system, or a suspension control system. The techniques described herein may also relate to transmitting, from the computing system to the mobile computing system while the mobile computing system is nonstationary, a vehicle operation profile comprising control data for controlling one or more vehicle components at a vehicle at which the mobile computing system is configured. A pricing element comprises one or more of a vehicle insurance rate, a vehicle insurance discount, a vehicle usage rate, or a vehicle usage discount. The computing system may be one of a mobile communication device, a computer module removable affixed to a vehicle at which the mobile computing system is configured, or an engine control unit configured at the vehicle at which the mobile computing system is configured.

The techniques described herein may relate to a non-transitory computer-readable medium comprising instructions that, when executed by one or more computer processors, cause the one or more computer processors to perform operations comprising receiving, from a mobile computing system, while the mobile computing system is nonstationary, sensor data representing one or more movements of the mobile computing system; determining, while the mobile computing system is nonstationary, a quality value based at least in part on the one or more movements of the mobile computing system; determining, while the mobile computing system is nonstationary, a pricing element based at least in part on the quality value; determining, while the mobile computing system is nonstationary, an alternative quality value based at least in part on one or more alternative movements of the mobile computing system; generating, while the mobile computing system is nonstationary, instructions to present a data element on a display, the data element comprising an indication of at least one of the one or more alternative movements of the mobile computing system; and transmitting the instructions to the mobile computing system while the mobile computing system is nonstationary.

In the disclosed techniques, the sensor data may include data received from one or more sensors configured at the vehicle at which the mobile computing system is configured. The one or more sensors may comprise one or more of a camera, a lidar sensor, a radar sensor, a sonar sensor, an inertial sensor, a location sensor, an audio sensor, or an environment sensor. The techniques described herein may also relate to determining a user based at least in part on data received with the sensor data; and determining the quality value further based at least in part on user data associated with the user. The techniques described herein may further relate to determining, based at least in part on the user data, a vehicle operation profile comprising control data for controlling one or more vehicle components at a vehicle at which the mobile computing system is configured; and transmitting the vehicle operation profile to the mobile computing system while the mobile computing system is nonstationary. The techniques described herein may also relate to transmitting, to the mobile computing system while the mobile computing system is nonstationary, second instructions to control one or more vehicle components at a vehicle at which the mobile computing system is configured.

The techniques described herein may also relate to a system comprising one or more processors; and a non-transitory memory storing computer-executable instructions that, when executed, cause the one or more processors to perform operations comprising: receiving, from a mobile computing system, while the mobile computing system is nonstationary, sensor data representing one or more movements of the mobile computing system; determining, while the mobile computing system is nonstationary, a quality value based at least in part on the one or more movements of the mobile computing system; determining, while the mobile computing system is nonstationary, a pricing element based at least in part on the quality value; determining, while the mobile computing system is nonstationary, an alternative quality value based at least in part on one or more alternative movements of the mobile computing system; generating, while the mobile computing system is nonstationary, instructions to present a data element on a display, the data element comprising an indication of at least one of the one or more alternative movements of the mobile computing system; and transmitting the instructions to the mobile computing system while the mobile computing system is nonstationary.

The techniques described herein may also relate to transmitting, to the mobile computing system while the mobile computing system is nonstationary, second instructions to control one or more vehicle components at a vehicle at which the mobile computing system is configured. The one or more vehicle components comprise at least one of one or more autonomous vehicle components or one or more semi-autonomous vehicle components. The pricing element comprises one or more of a vehicle insurance rate, a vehicle insurance discount, a vehicle usage rate, or a vehicle usage discount. The sensor data comprises data received from one or more sensors configured at the vehicle at which the mobile computing system is configured. The one or more sensors comprise one or more of a camera, a lidar sensor, a radar sensor, a sonar sensor, an inertial sensor, a location sensor, an audio sensor, or an environment sensor.

The techniques described herein may also relate to a system for determining vehicle trip data, the system comprising means for receiving, from a mobile computing system, while the mobile computing system is nonstationary, sensor data representing one or more movements of the mobile computing system; means for determining, while the mobile computing system is nonstationary, a quality value based at least in part on the one or more movements of the mobile computing system; means for determining, while the mobile computing system is nonstationary, a pricing element based at least in part on the quality value; means for determining, while the mobile computing system is nonstationary, an alternative quality value based at least in part on one or more alternative movements of the mobile computing system; means for generating, while the mobile computing system is nonstationary, instructions to present a data element on a display, the data element comprising an indication of at least one of the one or more alternative movements of the mobile computing system; and means for transmitting the instructions to the mobile computing system while the mobile computing system is nonstationary.

### BRIEF DESCRIPTION OF THE DRAWINGS

FIG. 1 illustrates an example environment in which a vehicle may be traveling and the various systems and components that may interact with the vehicle and/or the vehicle driver to provide rapid vehicle operation feedback and control.

FIG. 2 is a flow diagram illustrating an example process for determining an optimization score and determining, based on the optimization score, vehicle controls within a rapid vehicle operation feedback and control framework according to the examples described herein.

FIG. 3 is a flow diagram illustrating an example process for determining a vehicle operation profile and generating vehicle control data based on the vehicle operation profile using a rapid vehicle operation feedback and control framework according to the examples described herein.

FIG. 4 is a flow diagram illustrating an example process for determining an optimized vehicle operation profile and generating vehicle control data based on the optimized vehicle operation profile using a rapid vehicle operation feedback and control framework according to the examples described herein.

FIG. 5 is a flow diagram illustrating an example process for determining a change to an optimization score and determining vehicle controls based on the change to the score within a rapid vehicle operation feedback and control framework according to the examples described herein.

FIG. 6 illustrates an example user device and example interfaces that may be generated by the disclosed rapid vehicle operation feedback and control system based on data generated using the techniques described herein.

FIG. 7 illustrates another example user device and example interfaces that may be generated by the disclosed rapid vehicle operation feedback and control system based on data generated using the techniques described herein.

FIG. 8 shows an example system architecture for a computing device that may be used to implement the systems and architectures described herein.

The detailed description is set forth with reference to the accompanying figures. In the figures, the left-most digit(s) of a reference number identifies the figure in which the reference number first appears. The use of the same reference numbers in different figures indicates similar or identical items.

### DETAILED DESCRIPTION

Certain implementations and examples of the disclosure will now be described more fully below with reference to the accompanying figures, in which various aspects are shown. However, the various aspects may be implemented in many different forms and should not be construed as limited to the implementations set forth herein. The disclosure encompasses variations of the examples, as described herein. Like numbers refer to like elements throughout.

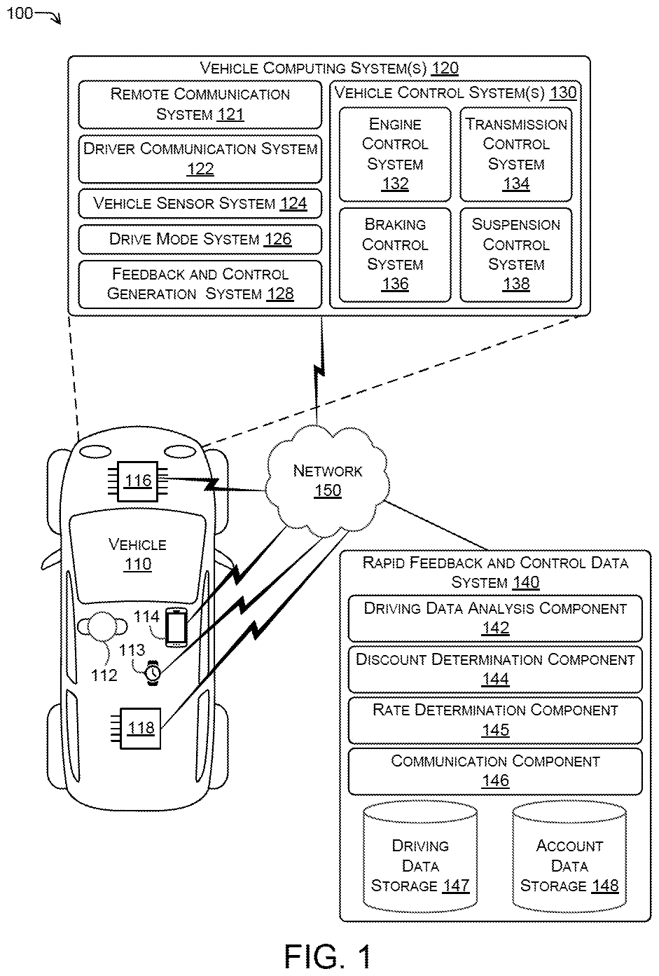

FIG. 1 illustrates an environment 100 in which a rapid vehicle operation feedback and control system may be implemented according to examples of the instant disclosure. A vehicle 110 may be configured in the environment 100 and may be any type of vehicle, such as a car, truck, motorcycle, boat, airplane, etc. The vehicle 110 may be operated by a driver 112. The vehicle 110 may also be occupied by one or more non-driver occupants (e.g., passengers).

The vehicle 110 may be configured with one or more of various vehicle computing systems 120, which may also be referred to as a mobile computing system. For example, the vehicle computing system(s) 120 may include a remote communication system 121 that facilitates communication between any of the components of the vehicle computing system(s) 120 and any one or more remote systems or components. For example, the remote communication system 121 may represent any one or more wireless communications components that may be configured to communicate with any one or more remote systems or components using any wireless communications means, including, but not limited to, any type of cellular communications and/or Wi-Fi communications. The remote communication system 121 may communicate wirelessly with a network 150 that may be any type of wireless computer network, including a cellular network and/or wireless local area network (LAN).

The vehicle computing system(s) 120 may also, or instead, include a driver communication system 122 that facilitates communication with the driver 112 and/or one or more occupants of the vehicle 110, including, but not limited to, communication based on data received from or via any of the other components of the vehicle computing system(s) 120, such as the remote communication system 121. For example, the driver communication system 122 may include one or more display components (e.g., screens) configured in the vehicle 110 to be visible to the driver 112 and/or one or more other occupants of the vehicle 110. The driver communication system 122 may also, or instead, include one or more audio components that may be configured to emit sounds that may be detectable by the driver 112 and/or one or more occupants of the vehicle 110. The driver communication system 122 may further, or instead, include any other types of visual and/or audible indicators that may be configured to present information of any type to the driver 112 and/or one or more occupants of the vehicle 110.

The vehicle computing system(s) 120 may also, or instead, include a vehicle sensor system 124 that may be configured to receive and/or generate sensor data based on one or more sensors that may be configured at the vehicle 110. For example, the vehicle 110 may be configured with one or more cameras, lidar sensors, radar sensors, sonar sensors, inertial sensors (e.g., accelerometer, magnetometer, gyroscope, etc.), time-of-flight sensors, location sensors (e.g., GPS component), audio sensors, acoustic sensors, microphones, environment sensors (e.g., temperature sensor, humidity sensor, light sensor, pressure sensor, etc.), and/or any combination thereof. The vehicle 110 may also, or instead, be configured with one or more vehicle component sensors, such as one or more engine sensors, braking system sensors, suspension sensors, etc. The vehicle sensor system 124 may further collect and/or receive data from one or more other vehicle components, such as a vehicle computer, a speedometer, an odometer, and/or any other component configured at the vehicle 110 that may generate data representing vehicle operation, state, and/or condition. These sensors, components, and/or the vehicle sensor system 124 may generate and/or receive sensor data that may be used to determine various vehicle operating conditions and/or driving behaviors, such as vehicle location, vehicle speed, vehicle acceleration, vehicle proximity to other vehicles and/or other objects in the environment 100, engine revolutions-per-minute (RPM), braking pressure, suspension settings, etc.

The vehicle computing system(s) 120 may also, or instead, include a drive mode system 126 that may be configured to determine various vehicle controls to operate the vehicle 110 according to a particular vehicle operation profile. For example, the drive mode system 126 may receive input requesting operation of the vehicle 110 in a particular mode, such as economy, sport, comfort, etc. As described in more detail herein, the requested mode may be an optimized vehicle control mode that may be based on an optimized vehicle operation profile that may improve an optimization score or factor that may be used to determine rates, discounts, and/or any other pricing elements that may be used to adjust the pricing of a product or service. A score or factor determined based on a driving or other performance quality may be referred to generally as a “quality value.” The drive mode system 126 may generate or determine and transmit various controls associated with the particular mode to one or more of the vehicle control system(s) 130 to control the vehicle 110 to operate according to the mode. For example, the drive mode system 126 may transmit instructions to limit acceleration, engine RPMs, and/or top speed to an engine control system based on a requested optimized vehicle control mode.

The vehicle computing system(s) 120 may also, or instead, include a feedback and control generation system 128 that may be configured to determine various data that may be used to implement rapid vehicle operation feedback vehicle and control operations. For example, the feedback and control generation system 128 may be configured to determine optimization scores, including retrieving and/or determining any data required to determine such scores. The feedback and control generation system 128 may also, or instead, be configured to generate suggestions, feedback, predictions, and/or other data that may represent alternative vehicle movements based on determined current and/or past optimization scores, driving behaviors, and/or vehicle operating conditions. Additional details regarding the determination and uses of optimization scores within a rapid vehicle operation feedback vehicle and control are described herein.

The vehicle computing system(s) 120 may also, or instead, include various vehicle control system(s) 130 that may control mechanical and operational components of the vehicle 110. The various vehicle control system(s) 130 may also, or instead, record or otherwise collect and store data associated with their various operations and conditions. For example, the vehicle control system(s) 130 may include an engine control system 132 may control various aspects of an engine of the vehicle 110 (e.g., fuel system, timing, ignition, etc.) and/or various operations of the engine of the vehicle 110 (e.g., acceleration, RPMs, top speed, etc.). In some examples, the engine control system 132 may include an engine control unit (ECU) and/or an engine control module (ECM). The engine control system 132 may include one or more replaceable and/or modifiable microchips (“chips”) that may be erasable and/or swappable memory chips that may perform engine control operations. For example, the vehicle 110 may include an ECU 116 that may be an engine control system and may be configured with one or more chips configured to control the vehicle 110 according to an optimized vehicle operation profile or an optimized vehicle control mode as described in more detail herein. The engine control system 132 may store data representing its operations, performance, controls received, controls implemented, conditions detected, etc. that may be used to determine driving behaviors and/or vehicle operating conditions and/or states.

The vehicle control system(s) 130 may also, or instead, include a transmission control system 134 that may be configured to control a transmission of the vehicle 110 and/or various operations of the transmission of the vehicle 110 (e.g., shift timing, gear selection, etc.). The transmission control system 134 may store data representing its operations, performance, controls received, controls implemented, conditions detected, etc. that may be used to determine driving behaviors and/or vehicle operating conditions and/or states.

The vehicle control system(s) 130 may also, or instead, include a braking control system 136 that may be configured to control a braking system of the vehicle 110 and/or various operations of the braking system of the vehicle 110 (e.g., brake pressure application, timing, etc.). The braking control system 136 may store data representing its operations, performance, controls received, controls implemented, conditions detected, etc. that may be used to determine driving behaviors and/or vehicle operating conditions and/or states.

The vehicle control system(s) 130 may also, or instead, include a suspension control system 138 that may be configured to control a suspension system of the vehicle 110 and/or various operations of the suspension system of the vehicle 110 (e.g., ride height, suspension firmness, suspension component pressure, etc.). The suspension control system 138 may store data representing its operations, performance, controls received, controls implemented, conditions detected, etc. that may be used to determine driving behaviors and/or vehicle operating conditions and/or states.

Configured at, or otherwise traveling with, the vehicle 110 may be one or more user devices that are distinct from vehicle components (e.g., that may be typically carried about by a human user, such as the driver 112). For example, a smartwatch 113 and/or a smartphone 114 may be present within the vehicle 110 (e.g., placed within the vehicle by the driver 112). One or more other types of mobile communications devices may also, or instead, be present within the vehicle 110. Each of the devices 113 and 114 may also have one or more sensors or combinations of sensors of any type as described herein. Each of the devices 113 and 114 may collect and locally store the data generated by the respective sensors configured at such devices. Each of the devices 113 and 114 may also, or instead, transmit such data to one or more remote devices. Each of the devices 113 and 114 may also, or instead, receive data from one or more remote devices for processing and presentation to the driver 112 and/or one or more occupants of the vehicle 110. Each of the devices 113 and 114 may also, or instead, generate one or more vehicle component controls based on received data and provide such controls to one or more components of the vehicle computing system(s) 120 (e.g., via the remote communication system 121). Each of the devices 113 and 114 may communicate with such remote systems via the network 150.

Other components of the vehicle 110 may also be configured to control various components of the vehicle 110 and/or communicate with remote systems. For example, the ECU 116 may be configured to interact with a remote system to determine various controls and configurations that it may use to control the engine of the vehicle 110. Similarly, the vehicle 110 may be configured with a module 118 that may also be configured to interact with a remote system to determine various controls and configurations that it may use to control the engine and/or any other components of the vehicle 110. The ECU 116 and/or the module 118 may be configured to communicate with such remote components via the network 150. Alternatively or additionally, the ECU 116 and/or the module 118 may be configured using a physical communications means before or while configured at the vehicle 110 and may perform vehicle control operations based on such configurations without basing such operations on subsequent communications with one or more remote systems. The module 118 and/or the ECU 116 may be removably affixed to the vehicle 110 and/or one or more components configured at the vehicle 110.

A rapid feedback and control data system 140 may be configured to interact with one or more components and systems of the vehicle 110. The rapid feedback and control data system 140 may be configured to perform rapid analysis of driving behaviors and vehicle operations (e.g., vehicle operating conditions and/or states). Based on such analysis, the rapid feedback and control data system 140 may determine one or more effects on a user's optimization score that may be used to determine rates and discounts (e.g., insurance premiums, insurance premium discounts, vehicle usage rates, vehicle usage discounts, etc.) for which the user may eligible. Alternatively or additionally, the rapid feedback and control data system 140 may determine rates and discounts for which the user may be eligible based on an analysis of driving behaviors and vehicle operations (e.g., without necessarily utilizing an optimization score).

In examples, the rapid feedback and control data system 140 may include a driving data analysis component 142 that may be configured to determine an optimization score and/or otherwise generate driving quality data that may be used to determine rates and/or discounts. The driving data analysis component 142 may process received current driving behaviors and/or vehicle operation data, such as movement data for the vehicle and/or the associated mobile computing system(s) and/or vehicle computing system(s) (e.g., as transmitted by one or more components of the vehicle 110), to determine the optimization score and/or other driving quality data. In examples, the driving data analysis component 142 may determine a current optimization score based solely on current (e.g., most recently received) driving behaviors and/or vehicle operation data. Alternately or additionally, the driving data analysis component 142 may determine a current optimization score using historical driving behaviors and/or vehicle operation data. This data may be from a driving data storage 147. Newly generated optimization scores and/or other driving quality data may also be stored at the driving data storage 147 by the driving data analysis component 142.

The driving data analysis component 142 may provide determined optimization scores and/or other driving quality data to a discount determination system 144. The discount determination system 144 may determine an eligible discount (e.g., insurance discount, vehicle usage discount, vehicle rental discount, etc.) for a user based on the user's optimization scores and/or other driving quality data. For example, the optimization scores and/or other driving quality data may be associated with a user identifier (e.g., username, first and last name, account number, policy number, driver's license number, telephone number, email address, vehicle identifier (e.g., license plate, vehicle identification number (VIN), etc.), etc.). The discount determination system 144 may use such information to retrieve policy and/or account information from an account data storage 148. Based on the policy and/or account information, the discount determination system 144 may determine the discounts that may be available to the identified user. The discount determination system 144 may then determine, based on the user's optimization scores and/or other driving quality data, whether the user is eligible for any of the available discounts. The discount determination system 144 may provide the determined discount information to a communication component 146 for transmission to one or more components of the vehicle 110 for presentation to the user (e.g., driver 112).

The driving data analysis component 142 may also, or instead, provide determined optimization scores and/or other driving quality data to a rate determination component 145. The rate determination component 145 may determine an eligible rate (e.g., insurance rate, vehicle usage rate, vehicle rental rate, etc.) for a user based on the user's optimization scores and/or other driving quality data. The rate determination component 145 may use a user identifier associated with the optimization scores and/or other driving quality data to retrieve policy and/or account information from the account data storage 148. Based on the policy and/or account information, the rate determination component 145 may determine one or more rates that may be available to the identified user. The rate determination component 145 may then determine, based on the user's optimization scores and/or other driving quality data, whether the user is eligible for any of the available rates. The rate determination component 145 may provide the determined rate information to the communication component 146 for transmission to one or more components of the vehicle 110 for presentation to the user (e.g., driver 112).

The driving data analysis component 142 may be further configured to generate and/or determine one or more suggestions and/or vehicle controls that may be used to improve an optimization score and/or driving quality data (e.g., in order to improve a user's eligibility for various rates and discounts). For example, the driving data analysis component 142 may be configured to generate one or more recommendations that may be presented to the driver 112 for adjusting driving behaviors such that a subsequent optimization score may be improved relative to a current optimization score. Additionally or alternatively, the driving data analysis component 142 may be configured to generate one or more vehicle component controls that may be configured at the vehicle 110 that may result in adjusted vehicle operations such that a subsequent optimization score may be improved relative to a current optimization score.

The communication component 146 of the driving data analysis component 142 may receive data from the rate determination component 145, the discount determination system 144, and/or the driving data analysis component 142 and generate data that may be used to present information representing such data to a user (e.g., the driver 112). For example, the communication component 146 may receive a current optimization score and one or more suggestions from the driving data analysis component 142, rate data from the rate determination component 145 representing rates that the driver 112 is currently eligible for based on the current optimization score, and discount data from the discount determination system 144 representing discounts that the driver 112 is currently eligible for based on the current optimization score. The communication component 146 may generate a graphical user interface and/or instructions representative thereof for transmission to the vehicle computing system(s) 120. The driver communication system 122 of the vehicle computing system(s) 120 may receive these instructions and/or the interface and responsively generate a user interface that presents the current optimization score, suggestions, discount data, and rate data to the driver 112. These operations and additional operations that may be executed by the rapid feedback and control data system 140 and/or systems and components executing within a rapid vehicle operation feedback and control framework and described in more detail below.

Note that one or all of the functions and operations of the rapid feedback and control data system 140 and/or systems and components executing within a rapid vehicle operation feedback and control framework may be implemented on a user device, such as smartphone 114, that may communicate with the vehicle computing system(s) 120 to implement the disclosed operations.

By collecting driving behavior and vehicle operation data and rapidly processing (e.g., in real-time or near real-time) to determine the impact of such data on rates and discounts, and by generating suggestions and controls that may improve eligibility for rates and discounts that are provided to driver while the driver is operating a vehicle, the systems and techniques described herein facilitate the safer operation of vehicles and improved quality and timeliness of information provided to vehicle operators. The use of real-time or near real-time feedback to assist a driver in more optimally (e.g., more safely) operating a vehicle may reduce the number of accidents and violations involving the driver, thereby reducing costs to the provider of the vehicle, the insurer, and the insured. For example, by providing suggestions and/or controlling a vehicle for safer operations, the disclosed systems and techniques provide a faster and more efficient way to reduce vehicle-related costs compared to traditional techniques of periodically and sporadically determining driving quality and related discounts and rates.

The disclosed systems and techniques are applicable to many scenarios involving vehicles of any type. For example, the rates and discounts described herein may be vehicle insurance rates and discounts. In other examples, the rates and discounts described herein may be rates of vehicle rental or usage and discounts thereto. In still other examples, the rates and discounts described herein may be applicable to driver pay. For instance, drivers with higher optimization scores and/or better driving quality data may be paid at higher rates and/or subject to lower or no discounts to rates of pay. Similarly, paying passengers may pay more for rides in vehicles with drivers having higher optimization scores and/or better driving quality data or may accept lower rates and higher discounts for rides in vehicles with drivers having lower optimization scores and/or lower driving quality data. As will be appreciated, the disclosed systems, techniques, and frameworks may be applied to many other vehicle-related scenarios and all such applications are contemplated as within the scope of the instant disclosure.

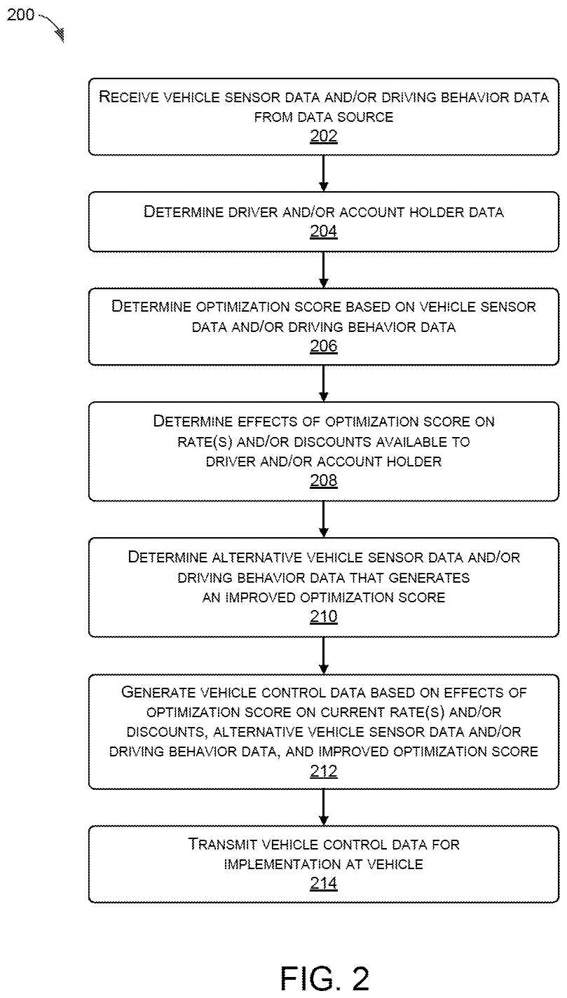

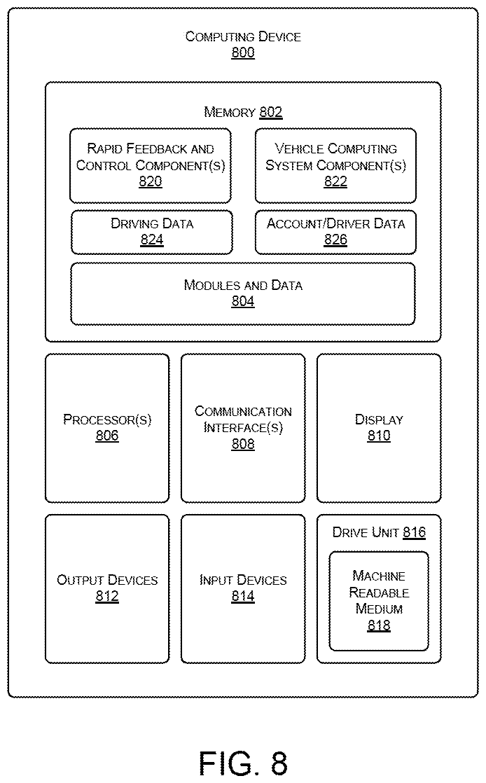

FIG. 2 is a flow diagram of an example process 200 for determining an optimization score and vehicle control data and providing such data for implementation at a vehicle in a rapid vehicle operation feedback and control system. In examples, one or more operations of the process 200 may be implemented by a vehicle computing system and/or a rapid feedback and control data system, such as by using one or more of the components and systems illustrated in FIG. 1 and described above and/or by using one or more of the components and systems illustrated in FIG. 8 and described below. For example, one or more such components and systems can include those associated with the vehicle computing system(s) 120 and/or rapid feedback and control data system 140 illustrated in FIG. 1. One or more such components and systems can also, or instead, include those associated with the computing device 800 illustrated in FIG. 8. In other examples, one or more operations of the process 200 may be performed by a combination of components described in regard to these systems and/or other systems. However, the process 200 is not limited to being performed by such components and systems, and the components and systems described herein are not limited to performing the operations of the process 200.

At operation 202, a rapid feedback and control system (e.g., rapid feedback and control system 140 and/or feedback and control generation system 128 of FIG. 1) may receive vehicle sensor data and/or driving behavior data from a data source. In examples, the data source may be any source of data that may be used to determine vehicle operations and/or driving behaviors, including data sources such as, but not limited to, the vehicle sensor system 124, the engine control system 132, the transmission control system 134, the braking control system 136, the suspension control system 138, the smartwatch 113, the smartphone 114, the ECU 116, the module 118, and/or any other vehicle component and/or system and/or any other system and/or component that may collect driving behavior data, vehicle state data, vehicle operation data, and/or vehicle condition data.

At operation 204, the system may determine the account holder or driver associated with the data received at operation 202. In examples, the data provided at 202 may include an identifier of an associated user or vehicle, such as a username, a first and last name, an account number, a policy number, a driver's license number, a telephone number, an email address, a vehicle identifier (e.g., license plate, VIN, etc.), and so forth. The system may use this information to obtain data for the associated user that may then be used to determine an optimization score and available rates and/or discounts. For example, a particular type of insurance policy may have associated rates and discounts that may be distinct from the rates and discounts available for another type of insurance policy.

At operation 206, the system may determine an optimization score based on the data received at operation 202. The optimization score may be a representation of a driving quality associated with a particular user at a particular time. In examples, the optimization score may be a numerical score within a range of scores (e.g., from 1-100), where a higher score may indicate a higher driving quality. “Driving quality” may be an indication of a safeness and/or efficiency of driving and/or a general indication of risk, and an optimization score may be a quantification of driving quality. Thus, a driver who is driving safely and therefore has a reduced risk of being involved in an accident may have a higher optimization score than a driver driving unsafely or otherwise at greater risk of being involved in an accident. Various means and/or techniques of determining such a score may be used and are contemplated as within the scope of the instant disclosure.

At operation 208, the system may determine the effects of the (e.g., current) optimization score on the rates and/or discounts that may be available for the driver. For example, the driver may be eligible for a 10% discount or a preferred rate by maintaining an optimization score at or above the current optimization score. The driver may also, or instead, be eligible for a 15% discount or a preferred-plus rate by raising the driver's optimization score by 10% over the next 30 days.

At operation 210, the system may determine alternative sensor data and/or driving behavior data that may improve the driver's optimization score. Continuing the example above, where the driver may be eligible for a 15% discount or a preferred-plus rate by raising the driver's optimization score by 10% over the next 30 days, the system may determine the changes in behavior and/or sensor data that may need to take place for such a score to be achieved. For instance, the system may determine that, to raise the optimization score by 10%, the vehicle may need to remain at or under the speed limit and not roll through any stop signs for the next 30 days.

At operation 212, the system may generate vehicle control data based on the determination of operation 210. “Vehicle control data” as used herein may be data that is used to control any one or more components of a vehicle and/or a system proximate to and/or in communication with the vehicle. For example, vehicle control data may be any data that controls vehicle components, such as a drive mode system (e.g., drive mode system 126 in FIG. 1) and/or any other vehicle control system (e.g., vehicle control system(s) 120 in FIG. 1). Such data may limit the vehicle's acceleration, RPMs, control braking and/or suspension, etc.

Alternatively or additionally, vehicle control data may be any data that controls information presentation components at or associated with a vehicle, such as a driver communication system, (e.g., driver communication system 122 of FIG. 1) and/or a smartphone and/or a smartwatch of a driver (e.g., smartphone 114, smartwatch 113 of FIG. 1). In such examples, the vehicle control data generated at operation 212 may be instruct a vehicle component to generate a graphical user interface presenting information representing any or all of the data generated in previous operations (e.g., optimization score, alternative vehicle behaviors, etc.). Such vehicle control data may take the form of suggestions or recommendations associated with driving behavior, such as behaviors to maintain or adjust to achieve the alternative behaviors and data that may result in an improved optimization score as determined at operation 210.

At operation 214, the determined vehicle control data may be transmitted to the vehicle for implementation at the vehicle. In examples, this may be a transmission via a network and one or more wireless communications connections to the vehicle that may cause an interface to be generated on a vehicle display (e.g., by the driver communication system 122 of FIG. 1) or may implement a particular limit or other configuration at a vehicle control system (e.g., activate an optimized vehicle operation profile at the drive mode system 126 in FIG. 1).

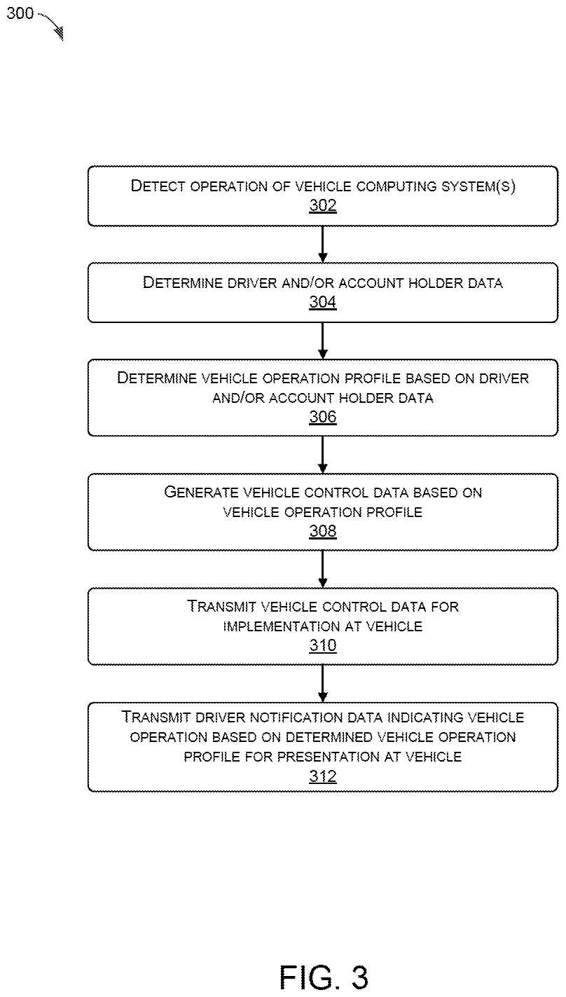

FIG. 3 is a flow diagram of an example process 300 for determining a vehicle operation profile and providing such a profile for use in determining vehicle controls for implementation at a vehicle in a rapid vehicle operation feedback and control system. In examples, one or more operations of the process 300 may be implemented by a vehicle computing system and/or a rapid feedback and control data system, such as by using one or more of the components and systems illustrated in FIG. 1 and described above and/or by using one or more of the components and systems illustrated in FIG. 8 and described below. For example, one or more such components and systems can include those associated with the vehicle computing system(s) 120 and/or rapid feedback and control data system 140 illustrated in FIG. 1. One or more such components and systems can also, or instead, include those associated with the computing device 800 illustrated in FIG. 8. In other examples, one or more operations of the process 300 may be performed by a combination of components described in regard to these systems and/or other systems. However, the process 300 is not limited to being performed by such components and systems, and the components and systems described herein are not limited to performing the operations of the process 300.

In examples, a vehicle operation profile may be determined for use in operating a vehicle based on a user's preferences and/or historical driving behavior and vehicle operations. This vehicle operation profile may be implemented at the vehicle automatically upon initiation of vehicle operation. For example, a safe operation mode may be activated at a vehicle drive mode component (e.g., the drive mode system 126 in FIG. 1) that limits acceleration and top speed. Alternatively or additionally, a vehicle operation profile may control or affect one or more autonomous or semi-autonomous functions of a vehicle, for example, by ensuring that a minimum distance is maintained between other vehicles in autonomous or semi-autonomous operation (e.g., adaptive cruise control), maintain speed below a particular level, braking gradually, etc. A vehicle operation profile may include control data for any of the vehicle control components and/or systems described herein and/or that may be used in the operation of a vehicle.

At operation 302, the operation of a vehicle computing system may be detected. This may be the start-up of a vehicle and the accompanying booting of one or more vehicle computing systems. This detection may be the result of an onboard vehicle computing system detecting initiation (e.g., one or more of the vehicle computing system(s) 120, such as the drive mode system 126 or the feedback and control generation system 128). Alternatively or additionally, the detection of initiation of operation of a vehicle computing system may be detected by a remote system, such as any system of the rapid feedback and control data system 140 that may receive a communication that may be transmitted by a vehicle component or system upon initiation (e.g., by any one or more of the vehicle computing system(s) 120 using the remote communication system 121 and via the network 150).

At operation 304, the system may determine a user (e.g., a driver or account holder) associated with the system detected at operation 302. In examples, an identifier of an associated user or vehicle, such as a username, a first and last name, an account number, a policy number, a driver's license number, a telephone number, an email address, a vehicle identifier (e.g., license plate, VIN, etc.), etc., may be provided with a communication indicating an initiation of a system detected at operation 302. Alternatively, where the process 300 is performed by an onboard system, the user identifier may not be needed, may be locally stored, and/or may be a default value (e.g., indicating the owner of the vehicle or policyholder associated with the vehicle).

At operation 306, a vehicle operation profile may be determined using the information determined at operation 304 (if applicable). This may be a user-selected or user-defined profile that, for example, includes controls intended to improve the user's optimization score. In some examples, the profile may be selected from one or more predefined profiles, such as economy, comfort, sport, and optimized vehicle operation. The determination of a profile may be performed automatically based on previous configurations implemented by the associated user and/or by the system. In other examples, at operation 306, the system may present to the user (driver) the available profiles on a graphical user interface and may request that the user select one of these for operating the vehicle.

At operation 308, the system may generate vehicle control data based on the determined vehicle operation profile. For example, the system may generate commands for the engine control system, braking control system, suspension control system, and/or transmission control system based on the profile. The system may also, or instead, generate commands to generate an interface on a vehicle component display presenting profile information to the driver.

At operation 310, the system may transmit these generated commands to the appropriate vehicle components. In some examples, these commands may be received from a remote system (e.g., the rapid feedback and control data system 140) at a vehicle computing system (e.g., at the vehicle computing system(s) 120 via the network 150 using the remote communication system 121) for implementation. In other examples, these commands may be received from a separate system (e.g., the smartphone 114, the smartwatch 113) at a vehicle computing system (e.g., at the vehicle computing system(s) 120 via Bluetooth or other short-range communications means using the remote communication system 121) for implementation. Alternatively, the commands may be generated locally by a vehicle component (e.g., the feedback and control generation system 128, the ECU 116, the module 118, etc.). The controls associated with the command may then be implemented at the intended components.

At operation 312, a notification may be generated informing the driver that the determined profile has been activated at the vehicle. For example, a user interface may be generated with one or more interface elements that indicate the profile and/or one or more associated controls or commands.

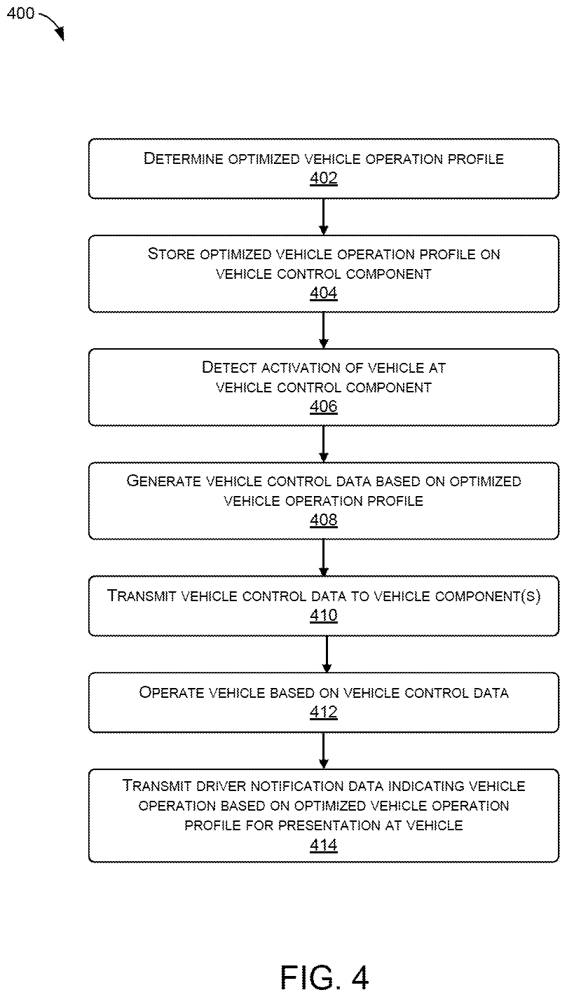

FIG. 4 is a flow diagram of an example process 400 for determining an optimized vehicle operation profile and providing such a profile for use in determining vehicle controls for implementation at a vehicle in a rapid vehicle operation feedback and control system. In examples, one or more operations of the process 400 may be implemented by a vehicle computing system and/or a rapid feedback and control data system, such as by using one or more of the components and systems illustrated in FIG. 1 and described above and/or by using one or more of the components and systems illustrated in FIG. 8 and described below. For example, one or more such components and systems can include those associated with the vehicle computing system(s) 120 and/or rapid feedback and control data system 140 illustrated in FIG. 1. One or more such components and systems can also, or instead, include those associated with the computing device 800 illustrated in FIG. 8. In other examples, one or more operations of the process 400 may be performed by a combination of components described in regard to these systems and/or other systems. However, the process 400 is not limited to being performed by such components and systems, and the components and systems described herein are not limited to performing the operations of the process 400.

In examples, an optimized vehicle operation profile may be determined for use in operating a vehicle. This vehicle operation profile may be implemented at the vehicle in a semi-permanent manner. For example, an optimized vehicle operation profile may be loaded onto an ECU or other module (e.g., ECU 116, module 118, of FIG. 1) and/or at a vehicle computing system or component (e.g., the drive mode system 126 in FIG. 1). This optimized vehicle operation profile may be configured to be a default operation profile for the vehicle. This optimized vehicle operation profile may implement vehicle controls that limit some capabilities of the vehicle and/or otherwise inhibit unsafe or less safe operation of the vehicle by a human driver. For example, these vehicle controls may limit the top speed, acceleration, etc. of the vehicle. The optimized vehicle operation profile may also, or instead, control or affect one or more autonomous or semi-autonomous functions of a vehicle, for example, by ensuring that a minimum distance is maintained between other vehicles in autonomous or semi-autonomous operation (e.g., adaptive cruise control), maintain speed below a particular level, braking gradually, etc. An optimized vehicle operation profile may include control data for any of the vehicle control components and/or systems described herein and/or that may be used in the operation of a vehicle.

At operation 402, an optimized vehicle operation profile may be determined. This may be a user-selected or user-defined profile that, for example, includes controls intended to improve the user's optimization score. In some examples, the profile may be a profile configured or generated by a service provider, such as an insurer, that may be intended to increase optimization scores.

At operation 404, the optimized vehicle operation profile may be stored on a vehicle control component. This component may or may not be configured at a vehicle when loaded with a profile. For example, the vehicle control component may be a module that may be attachable to the vehicle (e.g., module 118, ECU 116 of FIG. 1). The vehicle control component may be configured with the optimized vehicle operation profile and then transported to the vehicle for attachment to the vehicle and/or a vehicle computing system. For example, the vehicle control component may be configured to attach to an onboard diagnostic (OBD) port communicatively connected to a vehicle computing system. In other examples, the vehicle control component may be configured to attach to one or more ports or interfaces for exchanging communications with vehicle components, such as an interface to an ECU, a vehicle communication interface, a Controller Area Network (CAN) port, a Local Interconnect Network (LIN) port, etc.

At operation 406, the operation of a vehicle computing system may be detected. This may be the start-up a vehicle and the accompanying booting of one or more vehicle computing systems. This detection may be the result of an onboard vehicle computing system detecting initiation (e.g., one or more of the vehicle computing system(s) 120, such as the drive mode system 126 or the feedback and control generation system 128). Further at operation 406, the vehicle and/or vehicle computing system may detect the vehicle control component configured with the optimized vehicle operation profile.

At operation 408, system may generate vehicle control data based on the optimized vehicle operation profile. For example, the system may generate commands for the engine control system, braking control system, suspension control system, and/or transmission control system based on the optimized vehicle operation profile. The system may also, or instead, generate commands to generate an interface on a vehicle component display presenting optimized vehicle operation profile information to the driver.

At operation 410, the system may transmit these generated commands (vehicle control data) to the appropriate vehicle components. The commands may be generated locally by a vehicle component (e.g., the feedback and control generation system 128, the ECU 116, the module 118, etc.) that may be configured with the optimized vehicle operation profile. Alternatively, a vehicle component (e.g., the drive mode system 126 of FIG. 1) may detect the optimized vehicle operation profile (e.g., as stored in a separate module, such as module 118 of FIG. 1) and responsively generate and/or transmit the commands. At operation 412, the vehicle may be operated based on the vehicle control data (e.g., commands).

At operation 414, a notification may be generated informing the driver that the optimized vehicle operation profile has been activated or implemented at the vehicle. For example, a user interface may be generated with one or more interface elements that indicate the profile and/or one or more associated controls or commands.

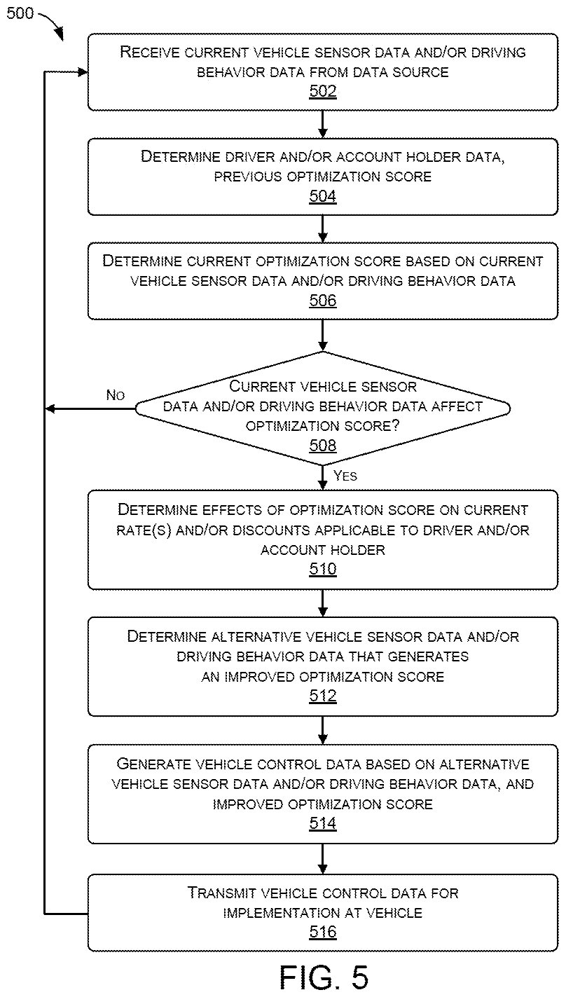

FIG. 5 is a flow diagram of an example process 500 for determining and updating the optimization score while a vehicle is being operated and generating vehicle controls based on the optimization score for implementation at a vehicle in a rapid vehicle operation feedback and control system. In examples, one or more operations of the process 500 may be implemented by a vehicle computing system and/or a rapid feedback and control data system, such as by using one or more of the components and systems illustrated in FIG. 1 and described above and/or by using one or more of the components and systems illustrated in FIG. 8 and described below. For example, one or more such components and systems can include those associated with the vehicle computing system(s) 120 and/or rapid feedback and control data system 140 illustrated in FIG. 1. One or more such components and systems can also, or instead, include those associated with the computing device 800 illustrated in FIG. 8. In other examples, one or more operations of the process 500 may be performed by a combination of components described in regard to these systems and/or other systems. However, the process 500 is not limited to being performed by such components and systems, and the components and systems described herein are not limited to performing the operations of the process 500.

At operation 502, a rapid feedback and control system (e.g., rapid feedback and control system 140 and/or feedback and control generation system 128 of FIG. 1) may receive current vehicle sensor data and/or driving behavior data from a data source. In examples, the data source may be any source of data that may be used to determine vehicle operations and/or driving behaviors, including data sources such as, but not limited to, the vehicle sensor system 124, the engine control system 132, the transmission control system 134, the braking control system 136, the suspension control system 138, the smartwatch 113, the smartphone 114, the ECU 116, the module 118, and/or any other vehicle component and/or system and/or any other system and/or component that may collect driving behavior data, vehicle state data, vehicle operation data, and/or vehicle condition data.

At operation 504, the system may determine the account holder or driver associated with the data received at operation 502. In examples, the data provided at 502 may include an identifier of an associated user or vehicle, such as a username, a first and last name, an account number, a policy number, a driver's license number, a telephone number, an email address, a vehicle identifier (e.g., license plate, VIN, etc.), and so forth. The system may use this information to obtain data for the associated user that may then be used to determine an optimization score and available rates and/or discounts. For example, a particular type of insurance policy may have associated rates and discounts that may be distinct from the rates and discounts available for another type of insurance policy. Further at 504, the system may determine the most recent optimization score for the identified driver and/or account holder.

At operation 506, the system may determine a current optimization score based on the data received at operation 502. This may be any optimization score as described herein, such as a numerical score within a range of scores (e.g., a score from a range of 1-100), where a higher score may indicate a higher driving quality. Various means and/or techniques of determining such a score may be used and are contemplated as within the scope of the instant disclosure.

At operation 508, the system may determine whether the current optimization score has been affected by the data received at operation 502. For example, the system may determine if the current optimization score determined at operation 506 is different than the previous optimization score determined at 504.

If, at operation 508, there is no effect on the optimization score, the system may return to operation 502 to continue receipt of vehicle sensor data and/or driving behavior data to perform subsequent optimization score determinations.

If, at operation 508, the current optimization score varies from the previous optimization score, at operation 510, the system may determine the effects of the current optimization score on the rates and/or discounts that may be available for the driver. For example, the driver may be eligible for a 10% discount or a preferred rate by maintaining an optimization score at or above the current optimization score. The driver may also, or instead, be eligible for a 15% discount or a preferred-plus rate by raising the driver's optimization score by 10% over the next 30 days. In other examples, the current optimization score may have no effect on the rates and/or discounts available to the associated driver, for example where the score is the same as the most recently previously determined score and/or where the driver is already taking advantage of the rates and/or discounts for which the driver is currently eligible.

At operation 512, the system may determine alternative sensor data and/or driving behavior data that may improve the driver's optimization score. Continuing the example used above, where the driver may be eligible for a 15% discount or a preferred-plus rate by raising the driver's optimization score by 10% over the next 30 days, the system may determine the changes in behavior and/or sensor data that may need to take place for such a score to be achieved. For instance, the system may determine that, to raise the optimization score by 10%, the vehicle may need to remain at or under the speed limit and not roll through any stop signs for the next 30 days.

At operation 514, the system may generate vehicle control data based on the determination of operation 512. This vehicle control data may be data that is used to control any one or more components of a vehicle and/or a system proximate to and/or in communication with the vehicle and/or any data that controls information presentation components at or associated with a vehicle. Such vehicle control data may take the form of suggestions or recommendations associated with driving behavior, such as behaviors to maintain or adjust to achieve the alternative behaviors and data that may result in an improved optimization score as determined at operation 512.

At operation 516, the determined vehicle control data may be transmitted to the vehicle for implementation at the vehicle. In examples, this may be a transmission via a network and one or more wireless communications connections to the vehicle that may cause an interface to be generated on a vehicle display (e.g., by the driver communication system 122 of FIG. 1) or may implement a particular limit or other configuration at a vehicle control system (e.g., activate an optimized vehicle operation profile at the drive mode system 126 in FIG. 1). The process 500 may be repeated relatively continuously or periodically while the vehicle is being operated, is in motion, and/or is nonstationary to provide rapid feedback to the driver and facilitate improved driving behaviors.

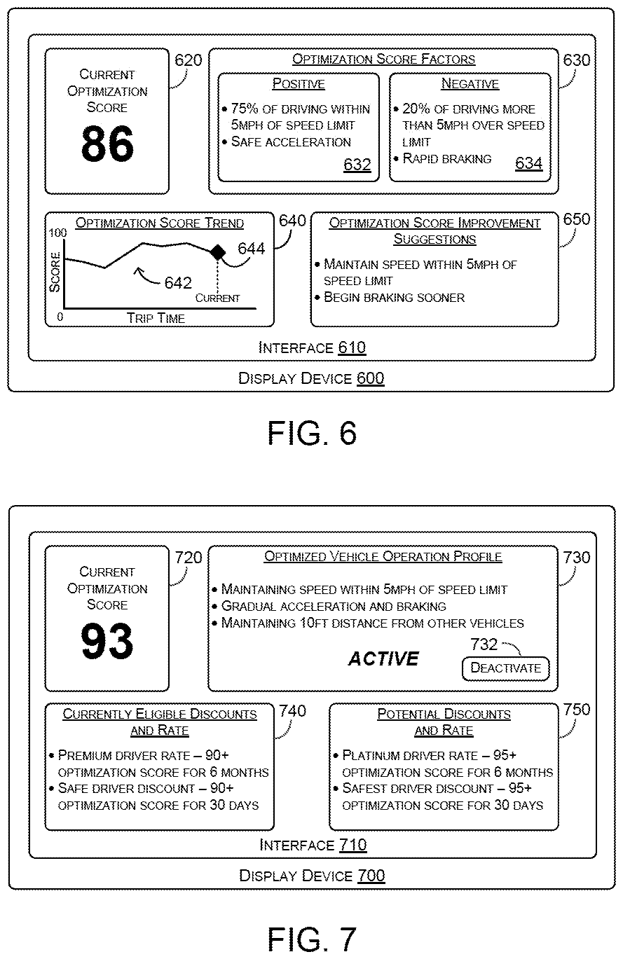

FIG. 6 illustrates an example user interface 610 that may be presented on a display device 600. The display device 600 may be a display of any computing and/or user device described herein. The interface 610 may be generated by a vehicle computing system (e.g., the driver communication system 122 of the vehicle computing system(s) 120, based on instructions generated by the feedback and control generation system 128 in FIG. 1) and/or a component of a rapid feedback and control data system (e.g., the communication component 146 of the rapid feedback and control data system 140 in FIG. 1) that may be configured to interoperate or otherwise control the display device 600 for facilitating the presentation of optimization score data and related rate, discount, driving behavior, and vehicle operation data. The data presented may also include vehicle controls and driver suggestions and recommendations. The interface 610 may be generated using data stored in a memory of a computing system and associated with an interface generation application (e.g., web browser) and based on data received from another system, such as a rapid feedback and control data system and/or a feedback and control generation system.

In examples, the interface 610 may include an interface display element 620 that may present a current optimization score determined as described herein. The interface 610 may also include an interface display element 630 that may present information associated with various factors that may have been used to determine the optimization score and/or that may be associated with the optimization score. For example, the interface display element 630 may include an interface display element 632 that indicates positive factors that may have helped increase an optimization score. The interface display element 630 may also, or instead, include an interface display element 634 that indicates negative factors that may have helped decrease an optimization score.

The interface 610 may further include an interface display element 640 that may present a representation of an optimization score trend 642, including a representation 644 of the current optimization score. The data on which this trend is determined may be historical optimization score data and a current optimization score. This interface element may allow a user to quickly see a current trend in optimization score and responsively alter driving behaviors to continue a positive optimization score trend or correct a negative optimization score trend.

The interface 610 may further include an interface display element 650 that may present recommendations for improving the current optimization score determined as described herein. This information may include suggestions for altered driving behaviors and/or vehicle component control that are proposed or may be implemented automatically.

FIG. 7 illustrates an example user interface 710 that may be presented on a display device 700. The display device 700 may be a display of any computing and/or user device described herein. The interface 710 may be generated by a vehicle computing system (e.g., the driver communication system 122 of the vehicle computing system(s) 120 in FIG. 1) and/or a component of a rapid feedback and control data system (e.g., the communication component 146 of the rapid feedback and control data system 140 in FIG. 1) that may be configured to interoperate or otherwise control the display device 700 for facilitating the presentation of optimization score data and related rate, discount, driving behavior, and vehicle operation data. The data presented may also include vehicle controls and driver suggestions and recommendations. The interface 710 may be generated using data stored in a memory of a computing system and associated with an interface generation application (e.g., web browser) and based on data received from another system, such as a rapid feedback and control data system and/or a feedback and control generation system.

In examples, the interface 710 may include an interface display element 720 that may present a current optimization score determined as described herein. The interface 710 may also include an interface display element 730 that may present information associated with vehicle control implemented at the vehicle, for example, based on an optimized vehicle operation profile. For instance, the interface display element 730 may include an indication of the active profile and/or information indicating the controls in place for the profile. The interface display element 730 may further include a control element 732 that the driver may use to activate and/or deactivate the profile. Upon activation of this control while the profile is active, the profile may be deactivated. Alternatively, upon activation of this control while the profile is inactive, the profile may be activated. Alternatively, the interface display element may include a plurality of controls, each associated with a profile, that may allow a driver to activate a profile of choice.

The interface 710 may further include an interface display element 740 that may present information representing the discounts and/or rates that a driver is currently eligible for based on the current optimization score (e.g., as displayed by the interface display element 720). This information may include one or more requirements for achieving and maintaining eligibility for the illustrated discounts and/or rates, such as a minimum optimization score and a length of time the minimum optimization score must be maintained.

The interface 710 may further include an interface display element 750 that may present information representing the discounts and/or rates that a driver may become eligible for if the current optimization score (e.g., as displayed by the interface display element 720) is improved. This information may include one or more requirements for achieving and maintaining eligibility for the illustrated discounts and/or rates, such as a minimum optimization score and a length of time the minimum optimization score must be maintained.

FIG. 8 shows an example system architecture for a computing device 800 that may be implemented as (e.g., part of) any of the systems and devices described herein and/or may perform any of the operations and processes described herein. For example, the computing device 800 may represent any of the systems, devices, and components illustrated in FIG. 1. Moreover, the computing device 800 may represent any system configured to generate any of the interfaces described in regard to FIGS. 6 and 7 and/or any other interface described herein. Furthermore, the computing device 800 may represent any system configured to implement any of the operations described in regard to FIGS. 2-5 and/or any other operation described herein. The computing device 800 may be a server, computer, mobile device (e.g., smartphone, smartwatch), vehicle component, vehicle computing system, or any other type of computing device that may execute any of the operations described herein. In some examples, operations as described herein may be distributed among and/or executed by multiple computing devices 800.

A computing device 800 can include memory 802. In various examples, the memory 802 can include system memory, which may be volatile (such as RAM), non-volatile (such as ROM, flash memory, etc.), or some combination of the two. The memory 802 may further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 800. Any such non-transitory computer-readable media may be part of the computing devices 800.

The memory 802 may include modules and data 804 needed to perform operations as described herein by one or more computing devices 800. Included with such modules and data 804 and/or also stored in the memory 802 may be one or more rapid feedback and controls components 820, one or more vehicle computing system components 822, driving data 824, and/or account/driver data 826. The rapid feedback and controls component(s) 820 may perform any one or more of the operations related to rapid vehicle operation feedback and control as described herein. The vehicle computing system component(s) 822 may also perform any one or more of the operations related to rapid vehicle operation feedback and control as described herein. The driving data 824 may be any vehicle data, driver quality data (e.g., optimization scores and/or data used to generate optimization scores, any data associated with driving data storage 147 of FIG. 1), and/or related data (e.g., sensor data, trip data, condition data, environment data, etc.) described herein that may be stored in a memory such as memory 802 and/or used in any one or more of the operations related to rapid vehicle operation feedback and control as described herein. The account/driver data 826 may be any vehicle data, account data, policy data, rate data, discount data, and/or any other data (e.g., any data associated with account data storage 148 of FIG. 1) described herein that may be stored in a memory such as memory 802 and/or used in any one or more of the operations related to rapid vehicle operation feedback and control as described herein.

One or more computing devices 800 may also have processor(s) 806, communication interface(s) 808, display(s) 810, output device(s) 812, input device(s) 814, and/or drive unit(s) 816 that may include one or more machine-readable media 818.

In various examples, the processor(s) 806 can be a central processing unit (CPU), a graphics processing unit (GPU), both a CPU and a GPU, or any other type of processing unit. Each of the one or more processor(s) 806 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 806 may also be responsible for executing computer applications stored in the memory 802, which can be associated with common types of volatile (RAM) and/or nonvolatile (ROM) memory.

The communication interfaces 808 may include transceivers, modems, interfaces, antennas, telephone connections, and/or other components that can transmit and/or receive data over networks, telephone lines, or other connections.

The display(s) 810 can be any one or more of a liquid crystal display or any other type of display commonly used in computing devices. For example, the display(s) 810 may include a touch-sensitive display screen that may also act as an input device or keypad, such as for providing a soft-key keyboard, navigation buttons, and/or any other type of input.

The output device(s) 812 may include any sort of output devices known in the art, such as the display(s) 810, one or more speakers, a vibrating mechanism, and/or a tactile feedback mechanism. Output devices 812 may also include one or more ports for one or more peripheral devices, such as headphones, peripheral speakers, and/or a peripheral display.

The input device(s) 814 may include any sort of input devices known in the art. For example, input device(s) 814 may include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

In examples, one or more of the communications interface(s) 808, the output devices 812, and the input devices 814 may include an on-board diagnostic (OBD) port that may attach the computing device 800 to a vehicle computing system. In other examples, one or more of communications interface(s) 808, the output devices 812, and the input devices 814 may include one or more ports or interfaces for exchanging communications with vehicle components, such as an interface to an ECU, an engine control chip, etc. In other examples, one or more of communications interface(s) 808, the output devices 812, and the input devices 814 may include one or more vehicle communication interfaces and/or one or more vehicle communication protocol communications exchange means. In other examples, one or more of communications interface(s) 808, the output devices 812, and the input devices 814 may include one or more components and/or configurations that facilitate communications via a Controller Area Network (CAN), a Local Interconnect Network (LIN), and/or any other means of component intercommunications, wired and/or wireless, that may facilitate communication with a vehicle computing system.

The machine-readable media 818 of drive unit(s) 816 may store one or more sets of instructions, such as software or firmware, that embodies any one or more of the methodologies or functions described herein. The instructions can also reside, completely or at least partially, within the memory 802, processor(s) 806, and/or communication interface(s) 808 during execution thereof by the one or more computing devices 800. The memory 802 and the processor(s) 806 may also constitute machine-readable media 818.

With the techniques described herein, a scenario involving a vehicle operating in an environment may be more easily and accurately reconstructed, such as for use in documenting an insurance claim and/or addressing legal issues surrounding an incident involving the vehicle. Furthermore, the data used to recreate such a scenario may be more readily and accurately determined, which may, for example, allow the use of such data and/or reconstructions based thereon in related insurance, legal, and financial matters.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, at a computing system from a mobile computing system, while the mobile computing system is nonstationary, sensor data representing one or more movements of the mobile computing system;
determining, at the computing system, while the mobile computing system is nonstationary, a quality value based at least in part on the one or more movements of the mobile computing system;
determining, at the computing system, while the mobile computing system is nonstationary, a pricing element based at least in part on the quality value;
determining, at the computing system, while the mobile computing system is nonstationary, an alternative quality value based at least in part on one or more alternative movements of the mobile computing system;
generating, at the computing system, while the mobile computing system is nonstationary, instructions to present a data element on a display, the data element comprising an indication of at least one of the one or more alternative movements of the mobile computing system; and
transmitting the instructions from the computing system to the mobile computing system while the mobile computing system is nonstationary.

2. The method of claim 1, further comprising determining the one or more movements of the mobile computing system based at least in part on the sensor data.

3. The method of claim 1, further comprising transmitting, from the computing system to the mobile computing system while the mobile computing system is nonstationary, second instructions to control one or more vehicle components at a vehicle at which the mobile computing system is configured.

4. The method of claim 3, wherein the one or more vehicle components comprise one or more of:
an engine control system,
a braking control system,
a transmission control system, or
a suspension control system.

5. The method of claim 1, further comprising transmitting, from the computing system to the mobile computing system while the mobile computing system is nonstationary, a vehicle operation profile comprising control data for controlling one or more vehicle components at a vehicle at which the mobile computing system is configured.

6. The method of claim 1, wherein the pricing element comprises one or more of:
a vehicle insurance rate,
a vehicle insurance discount,
a vehicle usage rate, or
a vehicle usage discount.

7. The method of claim 1, wherein the computing system is one of:
a mobile communication device,
a computer module removable affixed to a vehicle at which the mobile computing system is configured, or
an engine control unit configured at the vehicle at which the mobile computing system is configured.

8. A non-transitory computer-readable medium comprising instructions that, when executed by one or more computer processors, cause the one or more computer processors to perform operations comprising:
receiving, from a mobile computing system, while the mobile computing system is nonstationary, sensor data representing one or more movements of the mobile computing system;
determining, while the mobile computing system is nonstationary, a quality value based at least in part on the one or more movements of the mobile computing system;
determining, while the mobile computing system is nonstationary, a pricing element based at least in part on the quality value;
determining, while the mobile computing system is nonstationary, an alternative quality value based at least in part on one or more alternative movements of the mobile computing system;
generating, while the mobile computing system is nonstationary, instructions to present a data element on a display, the data element comprising an indication of at least one of the one or more alternative movements of the mobile computing system; and
transmitting the instructions to the mobile computing system while the mobile computing system is nonstationary.

9. The non-transitory computer-readable medium of claim 8, wherein the sensor data comprises data received from one or more sensors configured at a vehicle at which the mobile computing system is configured.

10. The non-transitory computer-readable medium of claim 9, wherein the one or more sensors comprise one or more of:
a camera,
a lidar sensor,
a radar sensor,
a sonar sensor,
an inertial sensor,
a location sensor,
an audio sensor, or
an environment sensor.

11. The non-transitory computer-readable medium of claim 8, wherein the operations further comprise:
determining a user based at least in part on data received with the sensor data; and
determining the quality value further based at least in part on user data associated with the user.

12. The non-transitory computer-readable medium of claim 11, wherein the operations further comprise:
determining, based at least in part on the user data, a vehicle operation profile comprising control data for controlling one or more vehicle components at a vehicle at which the mobile computing system is configured; and
transmitting the vehicle operation profile to the mobile computing system while the mobile computing system is nonstationary.

13. The non-transitory computer-readable medium of claim 8, wherein the operations further comprise transmitting, to the mobile computing system while the mobile computing system is nonstationary, second instructions to control one or more vehicle components at a vehicle at which the mobile computing system is configured.

14. A system comprising:
one or more processors; and
a non-transitory memory storing computer-executable instructions that, when executed, cause the one or more processors to perform operations comprising:
receiving, from a mobile computing system, while the mobile computing system is nonstationary, sensor data representing one or more movements of the mobile computing system;
determining, while the mobile computing system is nonstationary, a quality value based at least in part on the one or more movements of the mobile computing system;
determining, while the mobile computing system is nonstationary, a pricing element based at least in part on the quality value;
determining, while the mobile computing system is nonstationary, an alternative quality value based at least in part on one or more alternative movements of the mobile computing system;
generating, while the mobile computing system is nonstationary, instructions to present a data element on a display, the data element comprising an indication of at least one of the one or more alternative movements of the mobile computing system; and
transmitting the instructions to the mobile computing system while the mobile computing system is nonstationary.

15. The system of claim 14, wherein the operations further comprise transmitting, to the mobile computing system while the mobile computing system is nonstationary, second instructions to control one or more vehicle components at a vehicle at which the mobile computing system is configured.

16. The system of claim 15, wherein the one or more vehicle components comprise at least one of one or more autonomous vehicle components or one or more semi-autonomous vehicle components.

17. The system of claim 14, wherein the pricing element comprises one or more of:
a vehicle insurance rate,
a vehicle insurance discount,
a vehicle usage rate, or
a vehicle usage discount.

18. The system of claim 14, wherein the sensor data comprises data received from one or more sensors configured at a vehicle at which the mobile computing system is configured.

19. The system of claim 18, wherein the one or more sensors comprise one or more of:
a camera,
a lidar sensor,
a radar sensor,
a sonar sensor,
an inertial sensor,
a location sensor,
an audio sensor, or
an environment sensor.

20. A system for determining vehicle trip data, the system comprising:
means for receiving, from a mobile computing system, while the mobile computing system is nonstationary, sensor data representing one or more movements of the mobile computing system;
means for determining, while the mobile computing system is nonstationary, a quality value based at least in part on the one or more movements of the mobile computing system;
means for determining, while the mobile computing system is nonstationary, a pricing element based at least in part on the quality value;
means for determining, while the mobile computing system is nonstationary, an alternative quality value based at least in part on one or more alternative movements of the mobile computing system;
means for generating, while the mobile computing system is nonstationary, instructions to present a data element on a display, the data element comprising an indication of at least one of the one or more alternative movements of the mobile computing system; and
means for transmitting the instructions to the mobile computing system while the mobile computing system is nonstationary.
